(19) United States
(12) Patent Application Publication
(10) Pub. No.: US 2015/0277751 A1
(43) Pub. Date: Oct. 1, 2015

(54) GESTURE SELECTION DATA INPUT METHOD AND DATA STORAGE MEDIUM HAVING GESTURE SELECTION SOFTWARE TOOL STORED THEREON FOR IMPLEMENTING THE SAME

(71) Applicant: Linpus Technologies, Inc., Taipei (TW)

(72) Inventor: Aseem Manmualiya, Taipei (TW)

(73) Assignee: Linpus Technologies, Inc., Taipei (TW)

(21) Appl. No.: 14/228,419

(22) Filed: Mar. 28, 2014

(51) Int. Cl. G06F 3/0488; G06F 3/0482; G06F 3/041; G06F 3/0484

(52) U.S. Cl. CPC G06F 3/04886; G06F 3/04842; G06F 3/0482; G06F 3/041; G06F 2203/04104

(57) ABSTRACT

Disclosed is a gesture selection data input method, including following steps: waiting for user input; receiving user input and storing the first position of touch; determining if it is a long touch event, if answer is negative, checking tapped key and getting the suggested candidate word for a candidate bar; otherwise, determining if it is a slide across a key boundary? if the answer is negative, checking tapped key and getting the suggested candidate word for a candidate bar; otherwise, getting the x-axis value of the first position; selecting the candidate word containing the x-axis value; inputting candidate word to the computer/device/screen; updating a candidate bar; and going back to wait for user input. Also disclosed is a data storing medium having a gesture selection software tool stored thereon for implementing the gesture selection data input method.

### BACKGROUND OF THE INVENTION

1. Field of the Invention

The present invention relates to a gesture selection data input method and a data storage medium having software tool, and in particular to a gesture selection data input method and a data storage medium having a gesture selection software tool stored thereon for implementing the same.

2. Related Arts

With the progress and development of information and telecommunication technology, the mobile devices are widely utilized and have become quite popular. In general, for a mobile device, such as a mobile phone, smart phone, or a tablet computer, a character input device, for example a keyboard or a virtual keyboard having touch sensitive screen capability is provided. As such, for communication using a mobile device, such as preparing and sending an electronic mail (e-mail) using a smart phone, the speed and efficiency of data input is essential. For this purpose, a technique is utilized for predicting (suggesting) candidates for words input by a user, and to prompt the predicted candidate words in a predetermined area (usually the upper area) of a screen. Then, it selects and inputs the candidate words according to the gesture action of the user (The gesture action is not used in prior arts as the heading above). In such a situation, a word prediction software tool is run by a processor to achieve such predictions.

In this respect, presently, there are three approaches for a user to input words on a keyboard or a virtual keyboard (from a keyboard to the device/computer) as described as follows:

1. Space Submission Approach:

As shown in FIG. 1, this method utilizes a space bar 12 located at the lower portion of the keyboard 10, to submit the highlighted word from the candidate bar 11 located on the upper portion of the keyboard 10. As shown in FIG. 1, while a user is typing, he will get some suggestions (or predictions) on the candidate bar. Wherein, one of those suggestions is usually highlighted, which means that if the user presses the space bar, then this highlighted word will be selected and input.

However, this approach of word input has the shortcomings that:

(1) only one word can be selected and input at a time; and

(2) the user has to move his/her finger down to press the space bar and submit word, that is time consuming and not very convenient and user friendly.

2. Tap Selection Approach:

Refer to FIG. 2, a candidate bar 21 is located on the upper portion of the keyboard 20, while a space bar 22 is located on the lower portion of the keyboard 20. This approach of data entry would require the user to tap one of the words on the candidate bar 21 and that particular word will be input.

Nevertheless, this approach of word input has the drawback that:

The user has to move his/her finger to the candidate bar 21 to select one of the words. In devices having larger screen, it is time consuming and very inconvenient for the user while typing and inputting the words.

3. A Continuous Stroke Word-Based Text Input Approach:

As shown in FIG. 3, a candidate bar 31 is located on the upper portion of the keyboard 30. This approach of data entry was disclosed in U.S. Pat. No. 7,098,896 of C. Kushler, R. Marsden, and is related to producing candidate words by continuously moving user finger on the keyboard. However, this technology only refers to producing the candidate words using gestures, but it is not the technology using gesture to select/input one of the candidate words as desired.

Therefore, presently, the design and performance of mobile device word input system and method is not quite satisfactory, and it has much room for improvement.

### SUMMARY OF THE INVENTION

In view of the problems and drawbacks of the prior art, the present invention provides a gesture selection data input method and a data storage medium having a gesture selection software tool stored thereon for implementing the same, to effectively overcome the shortcomings of the prior art.

A major objective of the present invention is to provide a gesture selection data input method and a data storage medium having a gesture selection software tool stored thereon for implementing the same, that is able to enhance the data input speed, efficiency, and accuracy of a user.

In order to achieve the above-mentioned objective, the present invention provides a data storage medium having a gesture selection software tool stored thereon for implementing a gesture selection data input method. Wherein the data storage medium is provided in a smart phone, while the software tool is stored in the data storage medium. The smart phone includes: a central processing unit (processor), a main memory with an Operation System (OS) stored therein, a touch sensitive screen having a virtual keyboard contained therein, a data storage device (medium) having a gesture selection software tool stored therein; a data storage device having a word database stored therein. Wherein, the touch sensitive screen, the virtual keyboard, the main memory are connected to the central processing unit; while data storage device (medium), and a data storage device are connected to the main memory.

In the present invention, the virtual keyboard on the screen of a smart phone can be divided into a plurality of areas depending on actual requirement, such as convenience of data entry. A gesture (or a slide) can be made by the user's finger on the virtual keyboard, and one of the candidate words can be selected according to an algorithm of a gesture selection software tool.

In this approach, the user can make a gesture with his finger on the virtual keyboard. Then, for the area in which the gesture is made, a particular candidate word can be selected and input. In case a gesture is made across the boundary of a key, then the candidate word corresponding to first position is selected and input.

In general, the touch of user's finger on the screen can be classified as: short touch on a key of the screen, a long touch on a key of the screen, a long touch across more than one keys of the screen (slide). In the present invention, “Gesture” means hand/finger movement, so that a user can make any kind of finger movement (or gesture) to select the candidate word. The term Gesture is used to include all types of finger movements on the virtual keyboard for a data input event. For example, a user making a line with his finger is a gesture, a user making a circle with his finger is a gesture, a user making any random movement with his finger is also a gesture, so that the user can make any type of gesture to select the candidate word on the virtual keyboard to achieve data entry.

The present invention also provides a gesture selection data input method, that is realized through utilizing a gesture selection software tool to increase data input speed, efficiency, and accuracy of a user, including the following steps:
1. the gesture selection software tool initiates a virtual keyboard start state;
2. the gesture selection software tool waits for user input;
3. the gesture selection software tool receives the user input touch and stores the first position of the touch;
4. the gesture selection software tool determines if it is a long touch event ?
5. if the answer is negative, the gesture selection software tool checks the tapped key and gets the suggested candidate word for the candidate bar; then it goes to step 11;
6. otherwise, the gesture selection software tool determines if it is a slide across a key boundary ?
7. if the answer is negative, the gesture selection software tool checks the tapped key and gets the suggested candidate word for the candidate bar; then it goes to step 11;
8. otherwise, the gesture selection software tool determines that it is a gesture, and gets the x-axis value of the first position;
9. the gesture selection software tool selects the candidate word corresponding to the x-axis value of the first position;
10. the gesture selection software tool inputs the candidate word corresponding to the first position of the slide to a computer/device/screen;
11. the gesture selection software tool updates the candidate bar; and
12. the gesture selection software tool returns to step 2, to wait for user input.

Summing up the above, after executing the process above from steps 1 to 12 the first time, and while the user is not typing, the virtual keyboard remains in a “waiting for user's data input” state.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a virtual keyboard used for Space Submission Approach data entry according to the prior art;

FIG. 2 is a schematic diagram of a virtual keyboard used for Tap Selection Approach data entry according to the prior art;

FIG. 3 is a schematic diagram of a virtual keyboard used for Producing Candidate Words Using Gesture Approach according to the prior art;

FIG. 4 is a schematic diagram of a virtual keyboard used for the Gesture Selection Approach data entry according to an embodiment of the present invention;

FIG. 5 is a schematic diagram of a data storage medium having a gesture selection software tool stored thereon in a smart phone for implementing a gesture selection data input method according to an embodiment of the present invention; and

FIG. 6 is a flowchart of the steps of a gesture selection data input method according to an embodiment of the present invention.

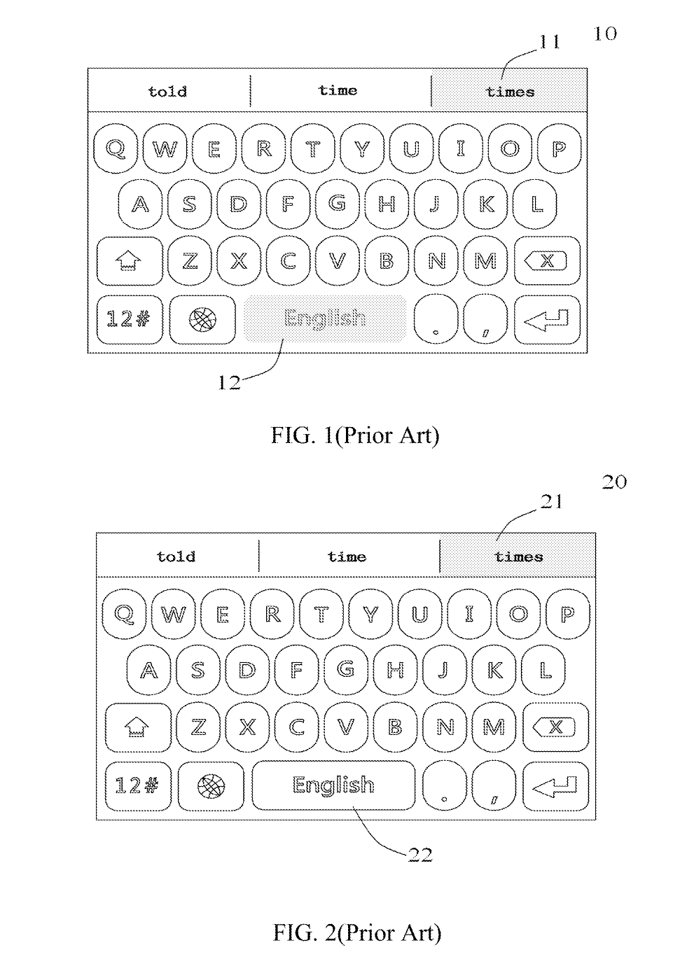

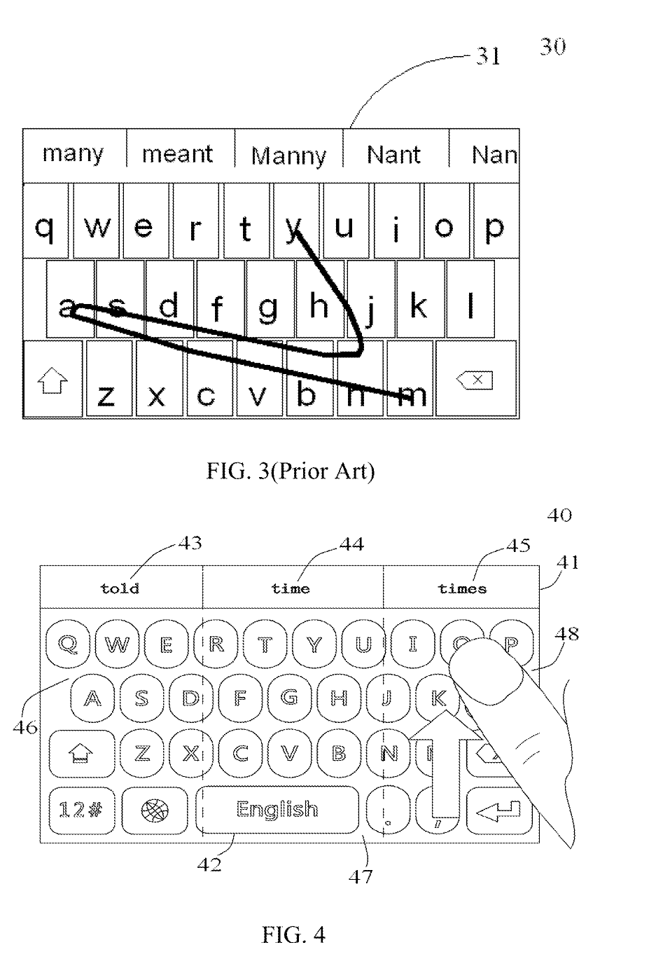

### DETAILED DESCRIPTION OF THE PREFERRED EMBODIMENT

The purpose, construction, features, functions and advantages of the present invention can be appreciated and understood more thoroughly through the following detailed description with reference to the attached drawings.

Firstly, refer to FIG. 4 for a schematic diagram of a virtual keyboard used for the Gesture Selection Approach data entry according to an embodiment of the present invention. As shown in FIG. 4, on the virtual keyboard 40 is provided with a candidate bar 41, a space bar 42, and a keyboard area. Wherein, the candidate bar 41 is divided into the first word area 43, the second word area 44, and the third word area 45; while the keyboard area is divided into the first keyboard area 46, the second keyboard area 47, and the third keyboard area 48. As such, the user can make a gesture with his finger on the virtual keyboard, to perform word typing, word prediction, word selection, and word entry.

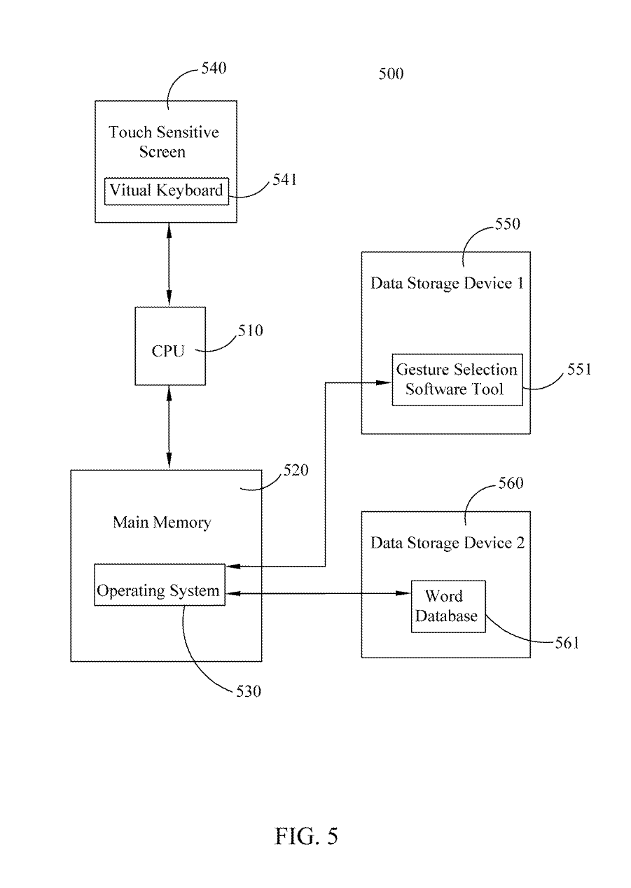

Then, refer to FIG. 5 for a schematic diagram of a data storage medium having a gesture selection software tool stored thereon in a smart phone to implement a gesture selection data input method according to an embodiment of the present invention. As shown in FIG. 5, the smart phone 500 includes: a central processing unit (CPU) 510, a main memory 520 with an Operation System (OS) 530 stored therein, a touch sensitive screen 540 having a virtual keyboard 541 contained therein, a data storage device (medium) 1 (550) having a gesture selection software tool 551 stored therein; and a data storage device 2 (560) having a word database 561 stored therein. Wherein, the touch sensitive screen 540, the virtual keyboard 541, the main memory 520 are connected to the central processing unit (CPU) 510; while data storage device (medium) 1 (550), a data storage device 2 (560) are connected to the main memory 520, so that during operation of the system, the gesture selection software tool 551, word database 561 can be loaded into the main memory 520 for execution by the CPU 510.

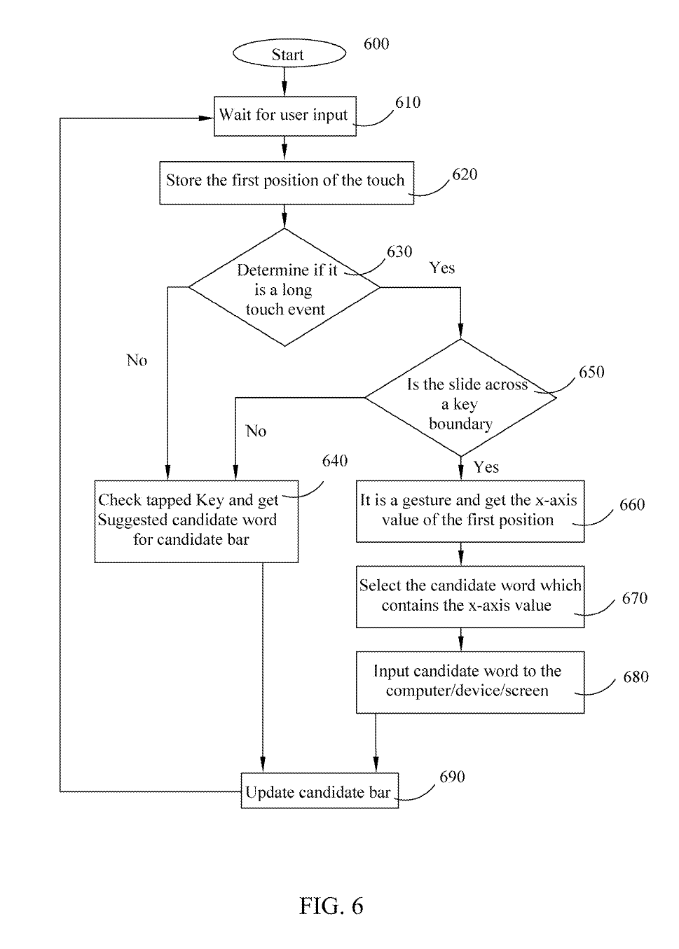

Furthermore, as shown in FIG. 6, the present invention also provides a gesture selection data input method, that is realized through a gesture selection software tool stored on a data storage medium, to increase data input speed, efficiency, and accuracy of a user, including the following steps:
1. in step 600, the gesture selection software tool initiates the virtual keyboard start state;
2. in step 610, the gesture selection software tool waits for user input;
3. in step 620, the gesture selection software tool receives the user input touch and stores the first position of the touch;
4. in step 630, the gesture selection software tool determines if it is a long touch event ?
5. if the answer is negative, the gesture selection software tool goes to step 640;
6. in step 640, the gesture selection software tool checks the tapped key and gets the suggested candidate word for the candidate bar; then it goes to step 690;
7. otherwise, in step 650, the gesture selection software tool determines if it is a slide across a key boundary ?
8. if the answer is negative, the gesture selection software tool goes to step 640;
9. otherwise, in step 660, the gesture selection software tool determines that it is a gesture, and gets the x-axis value of the first position;
10 in step 670, the gesture selection software tool selects the candidate word corresponding to the x-axis value of the first position;
11. in step 680, the gesture selection software tool inputs the candidate word corresponding to the first position of the slide to a computer/device/screen; and
12. in step 690, the gesture selection software tool updates the candidate bar; and then returns to step 610 to wait for user input.

In the description above, the suggested candidate word is generated by a word prediction software tool (not shown) of the prior art, but that will not be repeated here for brevity.

Then, refer to FIGS. 5 and 6 respectively. In the application of the present invention, as the user makes a slide on the virtual keyboard 541, this action is detected by the Gesture Selection Software Tool 551, then it checks if it is a slide event or just a short touch event. If it is a short touch event, it will check the tapped key and get the suggested candidate words for the candidate bar. Otherwise, if it is a slide event, then the Gesture Selection Software Tool 551 will select and input the right candidate word, and then update the candidate bar.

In the description above, a short touch on the virtual keyboard is for the user to type single character to get prediction words onto the candidate bar, while a slide (long touch) on the keyboard is for the user to select and input the corresponding candidate words onto the candidate bar.

In the present invention, the virtual keyboard of a smart phone is taken as an example for explanation, but the present invention is not limited to this. The present invention can be used in a keyboard of a mobile phone, a tablet computer, a handheld computer, a personal digital assistant (PDA), a personal computer (PC), or other devices having a screen to accommodate a virtual keyboard.

Moreover, the data storage medium mentioned above can be a magnetic or an optical media, for example, disk (fixed or removable), tape, CD-ROM, DVD-ROM, CD-R, CD-RW, DVD-R, DVD-RW. It may also include volatile or non-volatile memory media such as RAM, SDRAM, RDRAM, SRAM, ROM, but the present invention is not limited to this.

Summing up the above, the advantage of the Gesture Selection (Slide Selection) data entry utilized in the present invention has the following advantages:

In the prior art, a user has to move his finger to the space bar or the candidate bar to input the word, and that involves a two-step procedure:

a. move the finger to the space bar or the candidate bar;

b. tap the space bar or the candidate bar;

In contrast, in the present invention,

a. any of the candidate words can be selected with one gesture of finger;

b. the user does not have to move his/her finger to the candidate bar or space bar for data input, thus saving time, increasing the speed, efficiency, and accuracy of data input.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A gesture selection data input method, including the following steps:
(1) initiating a virtual keyboard start state;
(2) waiting for user input event;
(3) receiving a user input touch and storing a first position of said touch;
(4) determining if it is a long touch event?
(5) if answer is negative, checking a tapped key and getting suggested candidate word for a candidate bar; then going to (11);
(6) otherwise, determining if it is a slide across a key boundary;
(7) if answer is negative, checking said tapped key and getting said suggested candidate word for said candidate bar; then going to (11);
(8) otherwise, determining that it is a gesture, and getting the x-axis value of said first position;
(9) selecting said candidate word corresponding to x-axis value of said first position;
(10) inputting said candidate word corresponding to said first position of slide to a computer;
(11) updating said candidate bar; and
(12) returning to (2).

2. The gesture selection data input method as claimed in claim 1, wherein said suggested candidate word is generated by a word prediction software tool.

3. The gesture selection data input method as claimed in claim 1, wherein after executing from (1) to (12), and while said user is not typing, said virtual keyboard is in a “waiting user to input state”.

4. A data storing medium having a gesture selection software tool stored thereon to be executable by a processor, to
(1) initiate a start state;
(2) wait for a user input event;
(3) receive a user input touch and store a first position of said touch;
(4) determine if it is a long touch event;
(5) if answer is negative, check a tapped key to get a suggested candidate word for a candidate bar; then go to (11);
(6) otherwise, determine if it is a slide across a key boundary;
(7) if answer is negative, check said tapped key and get said suggested candidate word for said candidate bar; then go to (11);
(8) otherwise, determine that it is a gesture, and get x-axis value of said first position;
(9) select said candidate word corresponding to said x-axis value of said first position;
(10) input said candidate word corresponding to said first position of slide to a computer;
(11) update said candidate bar; and
(12) return to (2).

5. The data storing medium having a gesture selection software tool stored thereon to be executable by a processor as claimed in claim 4, wherein said suggested candidate word is generated by a word prediction software tool.

6. The data storing medium having a gesture selection software tool stored thereon to be executable by a processor as claimed in claim 4, wherein after executing from (1) to (12), and while said user is not typing, said virtual keyboard is in a “waiting user to input state”.
